(19) United States
(12) Patent Application Publication
(10) Pub. No.: US 2002/0196113 A1
(43) Pub. Date: Dec. 26, 2002

(54) Non-contact ignition switch

(76) Inventors: Jeffrey Rudd, Foxboro, MA (US); Matt Laplaca, Franklin, MA (US); Norm Poirier, Raynham, MA (US); Ronald I. Frank, Stoughton, MA (US); Bruce H. Brunquell, Methuen, MA (US)

Correspondence Address: Grossman, Tucker, Perreault & Pfleger, PLLC, Suite 604, 795 Elm Street, Manchester, NH, 03101, US

(21) Appl. No.: 10/150,875

(22) Filed: May 16, 2002

Related U.S. Application Data
(60) Provisional application No. 60/291,596, filed on May 16, 2001.

(51) Int. Cl. H01H 9/00

(52) U.S. Cl. 335/205

(57) ABSTRACT

A non-contact ignition switch. The switch may include an actuator element; a sensor spaced from the sensor actuator element for sensing the position of the actuator element, and a control circuit for providing an ignition state output in response to an output of the sensor. The sensor actuator element may be a magnet, and the sensor may be a Hall effect sensor.

### CROSS-REFERENCE TO RELATED APPLICATIONS

This application claims the benefit of the filing date of U.S. Provisional Application Ser. No. 60/291,596, filed May 16, 2001, the teachings of which are incorporated herein by reference.

### FIELD OF THE INVENTION

The present invention relates generally to ignition switches, and more particularly to an apparatus and system for incorporating an ignition switch with non-contact elements to provide a low cost and environmentally rugged ignition switch.

### BACKGROUND OF THE INVENTION

Nearly all diesel or gas power engines are equipped with ignition switch systems. Such ignition switches may be found on a variety of machinery and equipment including HVAC systems, vehicles, and the like. Such systems typically are a key ignition switch system or push button systems. The conventional key ignition switch system for vehicles is typically connected to a power source, e.g. a vehicle battery, via a conductor. Such a key ignition switch also typically includes several positions. These may include an accessory, control, run, and start position.

For vehicle applications, the vehicle systems are typically disabled when the ignition switch is in the off or control position. When the key is turned to the accessory or run position, the vehicle's accessories, e.g. the sound system, power windows, power sunroof, etc, are connected to the power supply so that they may be operated while the vehicle is not running. When in the run position, the ignition switch also typically provides a connection between the power supply and the engine controller. Finally, when the key is turned to the start position, a connection is made between the power supply and the engine controller to start the vehicle's engine. In addition, a relay mechanism for the start and run positions is also typically actuated in such instances. Similarly, such key ignition systems or push button systems may be utilized in other equipment or machinery.

Conventional ignition switches typically use metal contacts such as wipers to energize various circuits, e.g. start and run circuits, based on the position of the input device. In vehicles, and in particular construction vehicles, contaminants such as water, dirt, and dust can enter through the key opening. Water can cause corrosion of the metal contact and the contaminants adversely affect the reliability of the ignition switch.

Accordingly, there is a need in the art for a non-contact ignition switch that eliminates the need for metal contacts. There is further a need in the art for a low cost ignition switch that can operate in harsh environmental conditions and that may be utilized in a variety of applications needing ignition switches.

### SUMMARY OF THE INVENTION

An exemplary non-contact ignition switch consistent with the invention includes: at least one sensor actuator element; a sensor spaced from the sensor actuator element, the sensor being configured to provide an output in response to a position of the sensor actuator element; and a control circuit for providing an ignition state output in response to the output. The sensor actuator element may be a magnet, and the sensor may be a Hall effect sensor.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a block diagram of an exemplary non-contact ignition switch system consistent with the present invention;

FIG. 2 is a circuit diagram of an exemplary embodiment of a non-contact ignition switch utilizing a selectively magnetized carrier and non-contact magnetic sensors;

FIG. 3 is an exploded view of an exemplary non-contact ignition switch consistent with the invention;

FIG. 4 is a plan view of an exemplary selectively magnetized carrier consistent with the invention; and

FIG. 5 is an exemplary ignition position look-up table for various positions of a non-contact ignition switch.

### DETAILED DESCRIPTION

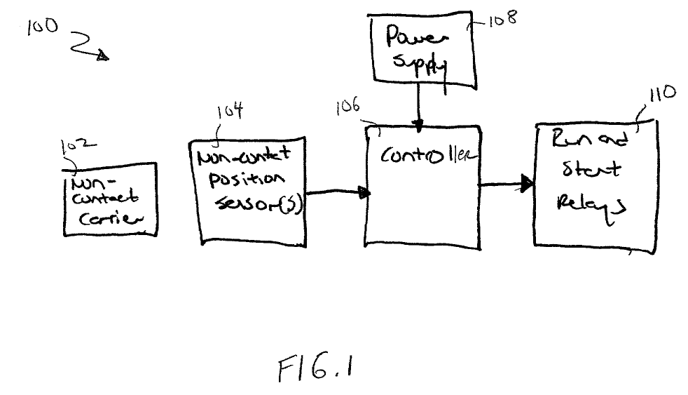

Referring to FIG. 1, there is illustrated a block diagram of a non-contact ignition switch system 100 consistent with the present invention. A non-contact carrier 102 may be coupled to a conventional ignition switch. A non-contact sensor 104 may be situated in proximity to the non-contact carrier. When a user switches an input device to various control positions, the non-contact carrier 102 is engaged to move a related amount. The non-contact sensor 104 is situated to detect the relative motion of the non-contact carrier 102 and to send associated signals to the controller 106. A power supply 108, e.g., a vehicle battery, provides power to the controller 106 and energizes appropriate circuits as necessary. When the input device is turned to either the start or run position, associated run and start relays 110 are appropriately energized to start and run the engine.

Advantageously, the non-contact position sensor(s) 104 and the non-contact carrier 102 are not connected by metal contacts so that they are more impervious to contaminants. In one embodiment, the sensor may be one or a plurality of magnetic sensors such as Hall sensors, and the non-contact carrier 102 may be a selectively magnetized encoder. The Hall sensors are situated to sense the changing magnetic flux created by movement of the carrier 102. Either one or a plurality of Hall sensors may be utilized.

Those skilled in the art will recognize, however, that a variety of sensing means may be used. For example, optical, magneto-resistive, fluxgate sensors etc. may be useful in connection with a sensor consistent with the present invention. Other sensors such as speed sensors e.g., conventional electrical, electro-optical are known in the art, and current sensors may be utilized to provide additional signals to the controller 106 detailing current operating conditions of the carrier 102. In addition, other carrier and sensor combinations including inductive or optical systems may be utilized without departing from the scope of the present invention.

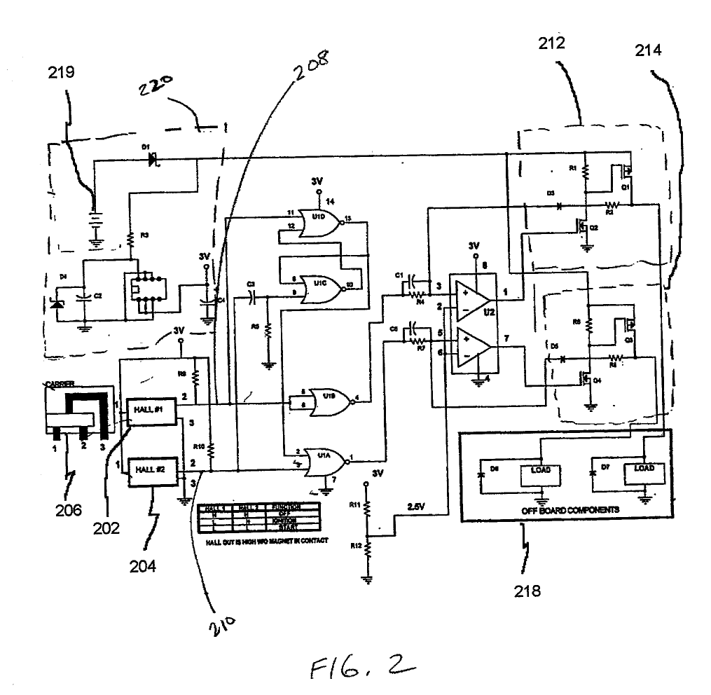

Turning to FIG. 2, a circuit diagram of one exemplary embodiment of a non-contact ignition switch using magnetic sensors such as Hall sensors is illustrated. Those skilled in the art will recognize a variety of configurations that may be utilized in a non-contact ignition switch consistent with the present invention. It is to be understood, therefore, that the embodiments described herein are described by way of illustration, not of limitation.

In the illustrated embodiment of FIG. 2, two Hall sensors 202 and 204 are utilized. Again, one or a plurality of Hall sensors may be utilized depending on system requirements. Advantageously, such Hall sensors 202 and 204 may be equipped with a sleep mode function. Such function allows lower power dissipation and regulated supply voltage to be utilized.

A carrier 206 may be selectively magnetized such that Hall sensors 202 and 204 output a high or low signal based on the relative orientation of the carrier 206 to the Hall sensors. In the illustrated embodiment, three functions corresponding to three different-states for the two Hall sensors 202 and 204 are illustrated. If the first Hall sensor's 202 output is high and the second Hall sensor's 204 output is high, the resulting control function is “off” corresponding to the input position of the ignition switch. A low output and a high output from the first 202 and second 204 Hall sensors results in a “ignition” control function, and similarly low outputs from both the first and second Hall sensor result in a “start” control function. Those skilled in the art will recognize that any variety of states may be used to achieve a variety of control functions depending on system requirements without departing from the scope of the present invention.

Output signals 208 and 210 from the Hall sensors 202 and 204 are input into various digital logic control circuitry. Various NOR gates or some other combination of logic gates may be utilized to produce desired control signals and control driver circuits such as an ignition or run driver circuit 212 and a start driver circuit 214. Such driver circuits drive associated starter and run relays 218.

Advantageously, the exemplary non-contact ignition switch may also directly switch the ignition coils without requiring a relay interface with the ignition and accessory coils. This reduces cost and improves reliability. In addition, low voltage potential of approximately 0.5 volts may only be necessary for the output switch circuits.

Such an exemplary system also provides protection against rapid manual manipulation. For example, some conventional ignition switches typically require that the switch be cycled back through the off position to re-enable the start function. However, by quickly turning the switch off, and then on again, the start function can be re-enabled even though the engine is still running. The exemplary system protects against such manipulation because the sensing mechanism is based on non-contact sensors as opposed to metal contacts.

A power supply 220 may include a battery 219. Advantageously, a power supply 220 may also include a reverse voltage protection circuit and/or an over voltage protection circuit providing short circuit battery power protection to the battery 219. The power supply 220 provides the necessary power to perform the necessary functions such as starting the engine.

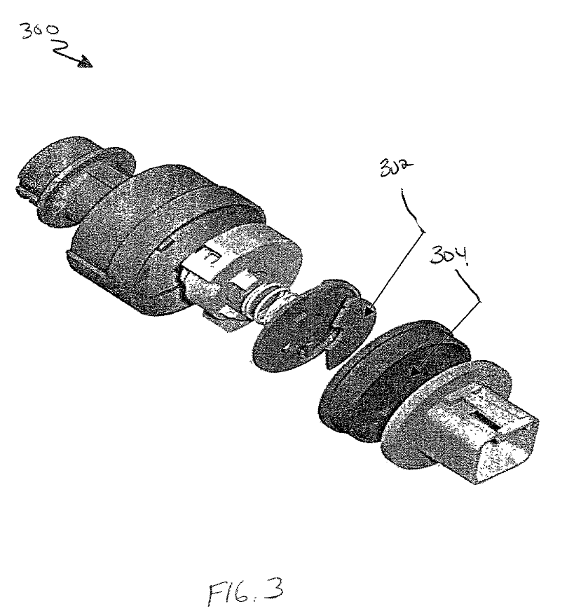

Turning to FIG. 3, an exploded view of an exemplary non-contact ignition switch 300 consistent with the present invention is illustrated. The embodiment of FIG. 3 utilizes a selectively magnetized encoder or carrier 302. Various non-contact or magnetic sensors, e.g., Hall sensors, detect the relative position of the carrier 302. A non-contact circuit 304 provides connection to a controller for performing various functions depending on the received signals from the sensors. The functions may include control, run, or start functions for example.

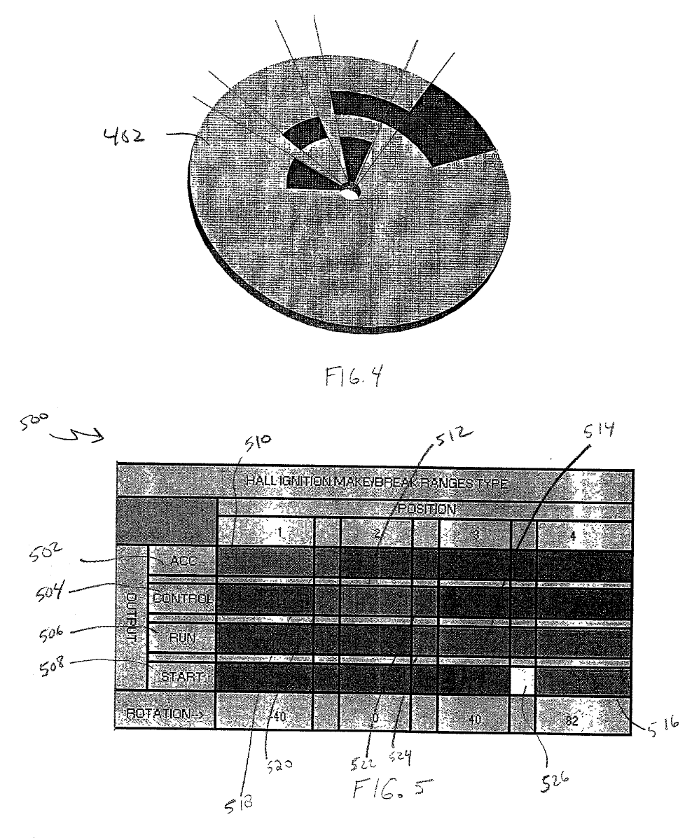

Turning to FIG. 4, an exemplary carrier 402 is illustrated. The carrier is selectively magnetized in various regions so that associated magnetic sensors may be selectively output a high or low signal depending on the relative position of the carrier 402. Therefore, as the carrier 402 is rotated the various magnetic regions rotate a related amount and selectively placed magnetic sensors detect the resulting changing magnetic flux and output corresponding high or low signals. Therefore, the carrier 402 and sensor combination provides position information to the controller, and hence corresponding output switching operations.

In addition, the carrier 402 may be selectively magnetized in any number of configurations depending on system requirements. Multiple outputs per switch position may be utilized. For example, the off position may be configured to provide battery voltage and accessory control. Each other position such as the run or start position may similarly have multiple outputs. The selectively magnetized carrier 402 may also have selective north and south magnetization on various magnetized strips.

In operation, as a user of a gas or diesel engine moves the ignition switch between various positions such as control, run, or start positions, the carrier 402 moves a related distance. This movement may be rotary movement as in the illustrated embodiment, or any other relative movement such as linear movement. The sensors detect this movement and provide the controller with position inputs.

The position input information from the non-contact sensors may be used to produce an exemplary look-up table 500 as illustrated in FIG. 5. In the exemplary look-up table 500, there are four positions that the ignition switch may activate. These are the accessory 502, control 504, run 506, and start 508 positions. When the carrier 402 is rotated by a minus 40 degrees, the accessory position is on 510. When the carrier 402 is at a start or 0 degree position, the control position 504 is on 512. Similarly, when the carrier is rotated to a plus 40 degree position, the run position 514 is on, and finally when the carrier is rotated to a full or plus 82 degree position the start position is on.

When the carrier 402 is rotated to other narrower zones 518, 520, 522, and 524 relative to its starting or 0 degree position, the controlled engine may be allowed to turn on only once. When the carrier 402 is rotated to other narrow zones 526, it may be allowed to turn on.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

What is claimed is:

1. A non-contact ignition switch comprising:
at least one sensor actuator element;
a sensor spaced from said sensor actuator element, said sensor being configured
to provide an output in response to a position of said sensor actuator element; and
a control circuit for providing an ignition state output in response to said output.

2. A non-contact ignition switch according to claim 1, wherein said sensor actuator element is a magnetic element.

3. A non-contact ignition switch according to claim 1, wherein said sensor actuator element is a magnetized region of a carrier element.

4. A non-contact ignition switch according to claim 1, wherein said sensor is a Hall effect sensor.

5. A non-contact ignition switch according to claim 1, said switch comprising a plurality of said sensor actuator elements, each of said sensor actuator elements comprising a magnetized region of a movable carrier element.

6. A non-contact ignition switch comprising:
a movable carrier element comprising a plurality of magnetic actuators thereon;
at least one Hall effect sensor spaced from said carrier element, said sensor being configured to provide a separate output in response to a plurality of positions of said magnetic actuators; and
a control circuit for providing an ignition state output in response to said outputs.

7. A non-contact ignition switch according to claim 6, wherein each of said magnetic actuators comprises a separate magnetized region of said carrier.
